(19) United States
(12) Patent Application Publication
(10) Pub. No.: US 2021/0298540 A1
(43) Pub. Date: Sep. 30, 2021

(54) Cleansing Device

(71) Applicant: Advanced Technologies for Tomorrow Today, LLC (ATfTT), Morgantown, WV (US)

(72) Inventors: James Earl Smith, Bruceton Mill, WV (US); John Charles Ruth, Morgantown, WV (US)

(21) Appl. No.: 17/210,766

(22) Filed: Mar. 24, 2021

Related U.S. Application Data
(60) Provisional application No. 62/994,628, filed on Mar. 25, 2020.

(51) Int. Cl. A47K 7/04; A46B 13/04

(52) U.S. Cl. CPC A47K 7/043; A46B 2200/1006; A46B 13/04

(57) ABSTRACT

A cleansing device includes a body, a head, an applicator, and a diaphragm. The body can define a handle. The head can be mechanically coupled to the body. The applicator can be arranged on a top of the head. The applicator can include an application surface and a back surface, and can define a plurality of openings. The diaphragm can be disposed within the head and against the back surface of the applicator. The diaphragm is configured to move in a reciprocating manner towards and away from the back surface of the applicator to create a suction force within the plurality of openings configured to draw contaminates away from pores of a cleansable surface that abuts the application surface of the applicator.

### RELATED APPLICATIONS

This application claims the benefit of priority under 35 U.S.C. § 119(e) of U.S. Provisional Application No. 62/994,628, filed Mar. 25, 2020, the content of which is incorporated herein by reference in its entirety.

### BACKGROUND

Facial pores can often accumulate oil, dirt, and other bodily deposits. Numerous cleansing techniques are available to exfoliate these regions. Some techniques require the use of chemicals such as alcohol and soap that can dissolve oils and the like and can assist in flushing visible residues from the surface of these regions. Some techniques can also cleanse the skin below the surface.

However, some of these techniques can be somewhat abrasive, leaving these facial regions abraded and exposed to bacteria and, therefore, possible infection. Further, unless the treatment cleans out the pores completely, the visible signs can remain or return quickly.

### SUMMARY

The present disclosure relates to facial cleansing products. In particular, this application describes a cleansing device for removing debris and other contaminants from facial pores. This application additionally describes an associated charging stand that may be utilized to wirelessly charge the cleansing device.

In a first aspect, a cleansing device can include a body, a head, an applicator, and a diaphragm. The body can define a handle. The head can be mechanically coupled to the body. The applicator can be arranged on the top of the head. The applicator can include an application surface and a back surface, and can define a plurality of openings. The diaphragm can be disposed within the head and against the back surface of the applicator. The diaphragm is configured to move in a reciprocating manner towards and away from the back surface of the applicator to create a pumping action within the plurality of openings that is configured to draw contaminates away from pores of a cleansable surface that abuts the application surface of the applicator.

In a second aspect, a cleansing device can include a body, a head, an applicator, a membrane, and a rotor. The body can define a handle. The head can be mechanically coupled to the body. The applicator can be arranged on the top of the head. The applicator can include an application surface and a back surface, and can define a plurality of openings. The membrane can be disposed within the head and against the back surface of the applicator. The membrane can include a top side configured to abut the backside of the applicator and a bottom side that defines a plurality of dimples. The plurality of dimples can be configured to align with the plurality of openings of the applicator. The rotor can be arranged within the head and below the membrane. The rotor can include one or more arms that extend in a radial direction parallel to the membrane, and the one or more arms can be configured to rotate below the membrane and press against the dimples during rotation to cyclically move regions of the membrane proximate the dimples in and out of the plurality of openings to create a pumping action within the plurality of openings to draw contaminates away from pores of a cleansable surface that abuts the application surface of the applicator.

In a third aspect, a covering for a cleansing device is disclosed. The covering can include an elastic band and a cleansing agent. The elastic band can be arranged around a perimeter of the covering and can facilitate securing the covering to a head of a cleansing device. The cleansing agent can be impregnated within the covering. The head of the cleansing device can include an applicator. The applicator can include an application surface and a back surface, and can define a plurality of openings. The diaphragm can be disposed against the back surface of the applicator. The diaphragm can be configured to move in a reciprocating manner towards and away from the back surface of the applicator to create a pumping action within the plurality of openings. The pumping action forces the cleansing agent in and out of pores of a cleansable surface.

In a fourth aspect, a cleansing device comprises a body that defines a handle and a head coupled to the body. The head comprises a contact surface that further defines an opening. The cleansing device further comprises a piston disposed within the opening. The piston is configured to move in a reciprocating manner towards and away from the contact surface to create a pumping action within the opening that is configured to draw contaminates away from pores of a cleansable surface that abuts the contact surface of the head.

### BRIEF DESCRIPTION OF THE DRAWINGS

The accompanying drawings are included to provide a further understanding of the claims, are incorporated in, and constitute a part of this specification. The detailed description and illustrated examples described serve to explain the principles defined by the claims.

FIG. 1A illustrates a cross-sectional view of a first cleansing device, in accordance with an example.

FIG. 1B illustrates a cross-sectional view of the first cleansing device partially disassembled, in accordance with an example.

FIG. 1C illustrates an applicator of the first cleansing device, in accordance with an example.

FIG. 1D illustrates a diaphragm of the first cleansing device, in accordance with an example.

FIG. 1E illustrates a top view of a covering, in accordance with an example.

FIG. 2A illustrates a cross-sectional view of a second cleansing device, in accordance with an example.

FIG. 2B illustrates a cross-sectional view of the second cleansing device partially disassembled, in accordance with an example.

FIG. 2C illustrates a rotor of the second cleansing device, in accordance with an example.

FIG. 2D illustrates a membrane of the second cleansing device, in accordance with an example.

FIG. 3 illustrates a cross-sectional view of a third example of a cleansing device 300 partially disassembled.

FIG. 4 illustrates operations performed in a method performed by a cleansing device, in accordance with an example.

FIG. 5A illustrates a cross-sectional view of a cleansing device, in accordance with an example.

FIG. 5B illustrates a top view of the cleansing device, in accordance with an example.

FIG. 6A illustrates a cross-sectional view of a cleansing device having a detachable head, in accordance with an example.

FIG. 6B illustrates a cross-sectional view of the cleansing device of FIG. 6A with the head removed, in accordance with an example.

FIG. 7A illustrates a perspective view of a charging stand holding a cleansing device, in accordance with an example.

FIG. 7B illustrates a perspective view of the charging stand without the cleansing device, in accordance with an example.

FIG. 7C illustrates a front view of the charging stand without the cleansing device, in accordance with an example.

### DETAILED DESCRIPTION

Various examples of systems, devices, and/or methods are described herein. Words such as “example” and “exemplary” that may be used herein are understood to mean “serving as an example, instance, or illustration.” Any embodiment, implementation, and/or feature described herein as being an “example” or “exemplary” is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein.

Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Moreover, terms such as “substantially,” or “about” that may be used herein, are meant that the recited characteristic, parameter, or value need not be achieved exactly, but that deviations or variations, including, for example, tolerances, measurement error, measurement accuracy limitations and other factors known to skill in the art, may occur in amounts that do not preclude the effect the characteristic was intended to provide.

### I. Overview

As noted above, some facial cleansing techniques can be somewhat abrasive, leaving facial regions abraded and exposed to bacteria. Disclosed herein is a cleansing device that facilitates removing debris and other contaminants from facial pores. Generally, the device includes a head having an applicator, at least a portion of which is stationary with respect to the surface to be cleaned. An example of the applicator includes a group of openings. A diaphragm or membrane is arranged behind the applicator. The diaphragm is moved in a reciprocating manner to create a pumping action within the openings (i.e., a change in pressure and/or suction force). In an example operation, a cleansing agent is applied to the applicator or directly to the skin, and the applicator is pressed against the skin. The pumping action within the openings of the applicator forces the cleansing agent to move in and out of the pores of the skin to cleanse the skin.

In some examples, a covering that includes a cleansing agent can be arranged over the applicator of the cleansing device. In these examples, the pumping action causes the cleansing agents in the covering to move in and out of the pores of the skin. Debris and other contaminants removed from the pores are then trapped in the covering. The covering can be disposed of and replaced. Coverings that are coated, impregnated, and/or saturated with different types of cleansing agents can be provided to facilitate different levels or types of skin treatment.

### II. Example Cleansing Device

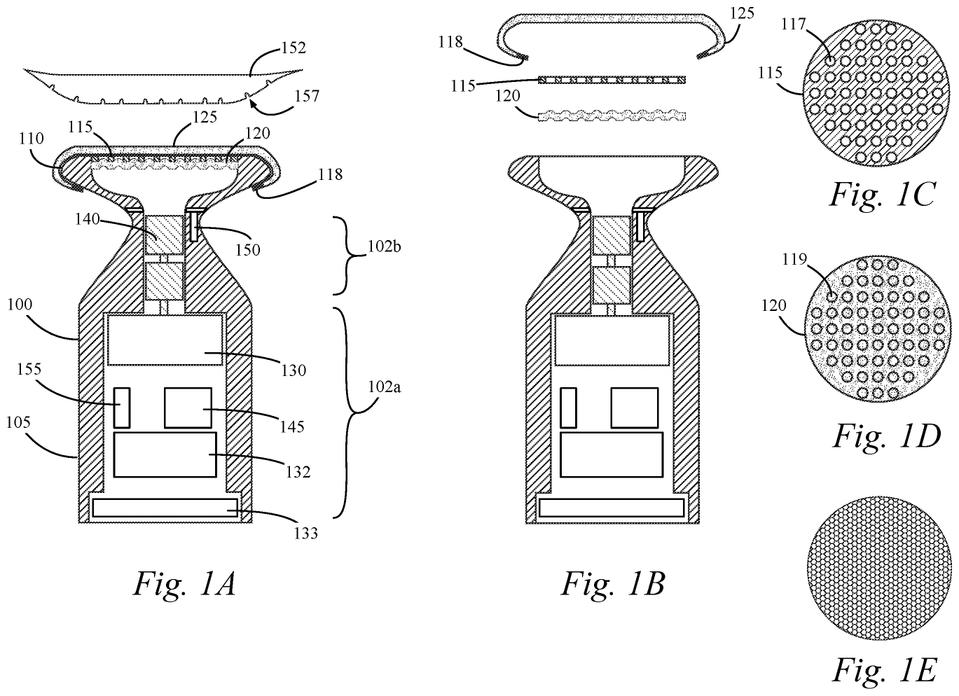

FIG. 1A illustrates a cross-sectional view of an example of a cleansing device 100. FIG. 1B illustrates a cross-sectional view of the cleansing device 100 partially disassembled. Referring to the figures, the cleansing device 100 includes a body 105, a head 110, an applicator 115, and a diaphragm 120. Some examples of the cleansing device 100 also include a covering 125, a motor 130, a battery 132, charging circuitry 133, a pump 140, a force sensor 150, a haptic device 155, and a controller 145. Also illustrated in the figures is an example of a cleansable surface 152 with pores 157 that can be cleaned by the cleansing device 100.

An example of the body 105 includes a handle region 102a and a neck region 102b. An example of the body 105 is formed from a rigid material such as a plastic or metallic material. Some examples of the body 105 include a rubberized coating that further facilitates securely holding the cleansing device 100. An example of the handle region 102a has a generally cylindrical outer shape and includes features that facilitate comfortably holding cleansing device 100 by hand, such as indentations for receiving fingers. An example of the handle region 102a is about 4 inches long and about 1.5 inches wide. It will be understood that other sizes, shapes, and/or form factors of various elements of cleansing device 100 are considered and possible.

An example of the neck region 102b is configured to couple to the head 110. In some examples, the neck region 102b is releasably coupled to the head 110. For instance, in an example, the neck region 102b and the head 110 define complementary threaded surfaces that mesh to facilitate screwing the head 110 to the neck region 102b of the body 105. In another example, a press/lock feature is used to couple the head 110 to the neck region 102b of the body 105. A release mechanism (e.g., a release button) can be provided to facilitate releasing the head 110 from the neck region 102b.

In some examples, a pivoting member (not shown) is provided between the head 110 and the neck region 102b to pivotally couple the head 110 to the neck region 102b of the body 105. This facilitates the rotational movement of the head 110 relative to the body 105. This, in turn, allows the head 110 to more easily follow/conform to contours of the cleansable surface 152 (e.g., facial contours) during cleansing operations.

In an example, the interior of the body 105 defines one or more hollow chambers that facilitate the insertion of one or more of the various components described above. For instance, an example of the neck region 102b of the body 105 defines a channel such as a cylindrical channel configured to receive the pump 140. The handle region 102a defines a cavity configured to hold one or more of the motor 130, battery 132, controller 145, etc.

An example of the head 110 has a generally hollow interior that is in fluid communication with the channel 135 defined in the neck region 102b of the body 105. In an example, the diameter of the head decreases from, for example, about 1.75 inches at the top end to about 0.75 inches at the point where the head 110 reaches the neck region 102b of the body 105. As noted above, an example of the head 110 can be removed from the neck region 102b of the body. This facilitates providing heads of different shapes and sizes. For example, a first head can be configured to be smaller than the example above to facilitate cleaning of hard-to-reach facial regions (e.g., nasal crease). A second head can be configured to be larger than the example above to facilitate cleaning of larger facial regions (e.g., cheeks).

An example of the applicator 115 is arranged within the top end of the head 110. An example of the applicator 115 is formed from a rigid or somewhat flexible material such as plastic or hardened rubber. An example of the applicator 115 has a generally planar shape, an application surface (i.e., surface facing the cleansable surface 152), and a back surface (i.e., opposite surface). An example of the applicator 115 has a circular shape with a diameter of about 1.5 inches. Other examples of the applicator 115 have different shapes and/or sizes to facilitate exfoliation of different facial regions.

As shown in FIG. 1C, an example of the applicator 115 defines a group of openings 117 or channels that extend completely through the applicator 115. Examples of the openings 117 are circular and have a diameter of about 0.2 inches. Other examples of the openings 117 can have a different shape and/or size. In some examples, the openings 117 are uniformly arranged on the applicator 115. For instance, in an example, the openings 117 are spaced apart by about 0.2 inches. In other examples of the applicator 115, the arrangement and the spacing of the openings 117 can be different.

An example of the applicator 115 is releasably coupled to the top of the head 110. For example, the applicator 115 can be snapped into the top end of the head 110. This facilitates swapping out the applicator 115 with an applicator 115 having a different configuration of openings. Removal of the applicator 115 can also facilitate access to and replacement of, for example, the diaphragm 120.

The diaphragm 120 is disposed against the back surface of the applicator 115. An example of the diaphragm 120 is formed from a flexible material such as a soft rubber material or a different elastomeric material. An example of the diaphragm 120 is generally planar and has a shape that generally matches the shape of the applicator 115 (e.g., a circular shape having a similar diameter). As shown in FIG. 1D, an example of the diaphragm 120 includes a group of dimples 119 or protrusions on a side that faces the applicator 115. In an example, the dimples 119 are arranged on the diaphragm 120 so that when assembled, the dimples 119 align with the group of openings of the applicator 115. Examples of the dimples 119 have a shape configured to form an air/liquid-tight seal with the openings. For instance, in an example, the dimples 119 have a circular shape and have a diameter of about 0.2 inches that matches the shape and size of the openings 117 of the applicator 115. The shapes and arrangements of the dimples 119 can be configured differently to match applicators 115 having different configurations of openings 117.

An example of the motor 130 corresponds to an AC or DC electric motor that receives power from a power source that can be internal to the cleansing device 100 (e.g., a battery) and/or external (e.g., via a power cord). An example of the motor 130 is mechanically coupled to the pump 140 (e.g., via a shaft). Activation of the motor 130 causes the pump 140 to increase pressure within the head 110. The increased pressure causes regions of the diaphragm 120 (e.g., the dimples 119) to displace/move into the openings 117 of the applicator 115 to an extent. When the motor 130 is deactivated, the pressure within the head 110 decreases to atmospheric pressure, and these regions of the diaphragm 120 subsequently retract to an extent from the openings 117 of the applicator 115.

In operation, cyclical activation and deactivation of the motor 130 causes a corresponding cyclic displacement of the volume within the openings 117 of the applicator 115 by the dimples 119 of the diaphragm 120. When the applicator 115 is pressed against the cleansable surface 152 (e.g., facial skin) with sufficient force, the cyclical action of the motor causes a corresponding pumping action or suction force within the openings 117 of the applicator 115. The pumping action forces cleansing agents arranged within these openings 117 in and out of the pores 157 of the cleansable surface 152 to remove debris and other contaminants contained therein. In some examples, the motor 130 cycles at a relatively low frequency, such as 5 Hz.

As noted above, additional components that can be arranged in or used with the cleansing device 100 can include a covering 125, a battery 132, a force sensor 150, a haptic device 155, and a controller 145.

An example of the covering 125 is configured to cover the applicator 115. A cleansing agent can be applied to the covering 125. Additionally, or alternatively, the covering 125 may have been previously coated, impregnated, and/or saturated with a cleansing agent. During operation, the pumping action noted above causes the cleansing agent in the covering 125 to move in and out of the pores 157 of the cleansable surface 152. The movement of the cleansing agent into the pores 157 removes debris and other contaminants from the pores 157. Debris and other contaminants removed from the pores 157 are captured within the covering 125. In this regard, some examples of the covering 125 are formed from low-cost materials. In this case, the covering 125 can be disposed of after use, and a replacement covering 125 can be arranged over the head 110 of the cleansing device 100.

As illustrated in FIG. 1E, some examples of the covering 125 include hollow cellular structures configured to retain cleansing agents such as cleansing fluids or cleansing compounds. In an example, the hollow cellular structures are configured to align with the direction of the movement of the dimples 119 of the diaphragm 120 to facilitate the improved flow of the cleansing agent to pores 157 of the cleansable surface 152. For instance, an example of the hollow cellular structure corresponds to a honeycomb shape with elastomeric properties. In this case, each cell of the hollow cellular structure can be configured to retain cleansing agents. Openings of the cells can be configured to abut the cleansable surface 152. When force is applied against the hollow cellular structure, the cells of the hollow cellular structure compress, and cleansing agents can be forced out of the cells and into the pores 157 of the cleansable surface 152. When the pressure is released, the cells of the hollow cellular structure expand and draw or suck cleansing agents from the pores 157. In some examples, the bottom surface of the covering 125 (i.e., the side facing the applicator 115) is configured so that the bottom side of each cell is closed, thereby concentrating movement of the cleansing agent towards the cleansable surface 152 rather than the applicator 115.

It should be noted that the size of the cells illustrated in FIG. 1E is exaggerated for clarity. For example, each cell can have a diameter of less than 0.1 inches and can have a depth of about 0.1 inches. The diameter and depth of each cell for a particular covering can depend on the type of cleansing agent to be applied and the size of the surface to be cleansed.

Some examples of the covering 125 include an elastic band 118 arranged around the perimeter of the covering 125. The elastic band 118 facilitates stretching the covering 125, which can further facilitate sliding the covering 125 over the head 110 of the cleansing device 100.

An example of the battery 132 is configured to provide power to the motor and/or the controller 145. An example of the battery 132 corresponds to a rechargeable battery such as a Lithium-Ion (LiIon) battery or a battery having a different chemistry. In this regard, an example of the cleansing device 100 includes charging circuitry 133 that facilitates charging the battery 132. An example of the charging circuitry 133 includes electrical contacts configured to couple to corresponding electrical contacts of an external power source (e.g., a charging base). In addition or alternatively, an example of the charging circuitry 133 includes wireless charging capabilities that facilitate wirelessly charging the battery 132. For instance, an example of the charging circuitry 133 includes energy receiving coils configured to receive energy from a wireless charging base.

An example of the force sensor 150 corresponds to a pressure sensor or a multipole spring-loaded switch. An example of the force sensor 150 is arranged between the head 110 and the neck region 102b of the body 105. An example of the force sensor 150 is configured to provide information to the controller 145 that facilitates determining, by the controller 145, an amount of force applied to the head 110 when the cleansing device 100 is in use. This aspect can facilitate the implementation of certain operations that are described below.

An example of the haptic device 155 is configured to provide haptic feedback (e.g., a momentary vibration) responsive to a command from the controller 145. An example of the haptic device 155 corresponds to an unbalanced motor, a linear actuator, etc., configured to indicate a particular mode of operation of the cleansing device 100. For example, haptic feedback can be provided to a user to indicate the desired amount of pressure against the face has been achieved. In some examples, an audio device (e.g., a piezoelectric speaker) is utilized to provide audible feedback to the user.

An example of the controller 145 includes a processor and a memory that is in communication with the processor. The processor is configured to execute instruction code stored in the memory. The instruction code facilitates performing, by the cleansing device 100, various operations that facilitate facial cleansing. In this regard, an example of the instruction code causes the processor to control and coordinate various activities performed by the different subsystems of the cleansing device 100. Examples of the processor can correspond to Intel®, AMD®, or ARM®, etc., processors.

A first example operation performed by the controller 145 involves cyclically activating and deactivating the motor 130 of the cleansing device 100. This action causes a cleansing agent arranged within the openings 117 of the applicator 115 and/or in the covering 125 to cycle in and out of the pores 157 of the cleansable surface 152. The movement of the cleansing agent into the pores 157 removes debris and other contaminants from the pores 157. Debris and other contaminants removed from the pores 157 can be captured within the covering 125.

A second example operation performed by the controller 145 involves determining an amount of force applied to the head 110 of the cleansing device 100 based on information communicated from the force sensor 150. In this example, the controller 145 controls the motor 130 to cyclically activate and deactivate when the amount of force measured by the force sensor 150 exceeds a first threshold. The amount of force associated with the first threshold can correspond to an amount of force sufficient to ensure a relatively air/liquid-tight seal between the cleansable surface 152 and the applicator 115.

A further example operation performed by the controller 145 involves controlling the haptic device 155 to provide haptic feedback when the amount of force measured by the force sensor 150 exceeds a threshold. For example, when the force exceeds the first threshold noted above, the controller 145 controls the motor 130 to cyclically activate and deactivate. When the force exceeds a second, higher threshold, haptic feedback can be provided to indicate to the user that the force between the head 110 and the cleansable surface 152 is sufficient to ensure a relatively air/liquid-tight seal between the cleansable surface 152 and the applicator 115.

### II. Second Example Cleansing Device

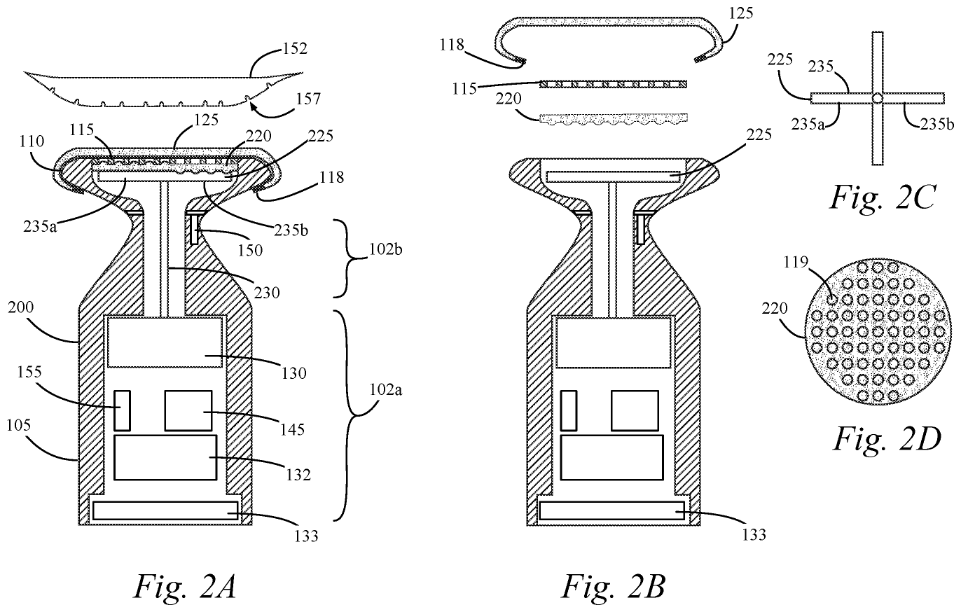

FIG. 2A illustrates a cross-sectional view of a second example of a cleansing device 200. FIG. 2B illustrates a cross-sectional view of the cleansing device 200 partially disassembled. Referring to the figures, the cleansing device 200 includes a body 105, a head 110, and applicator 115, a membrane 220, and a rotor 225. Additional components that can be arranged in or used with the cleansing device 200 can include a covering 125, a motor 130, a battery 132, charging circuitry 133, a force sensor 150, a haptic device 155, and a controller 145. Also illustrated in the figures is an example of a cleansable surface 152 with pores 157 that can be cleaned by the cleansing device 100.

The body 105, head 110, and applicator 115 of the second example cleansing device 200 are configured and/or perform similarly to the corresponding features associated with the first example cleansing device 100. Likewise, the covering 125, motor 130, battery 132, force sensor 150, haptic device 155, and controller 145 of the second example cleansing device 200 are configured and/or perform similarly to the corresponding features associated with the first example cleansing device 100. The description of these features will not be repeated for brevity. The primary difference between the first example cleansing device 100 and the second example cleansing device 200 is the use of a membrane 220 and a rotor 225 configuration to create the pumping action described above within the openings of the applicator 115.

In the second example cleansing device 200, the membrane 220 is disposed against the back surface of the applicator 115. An example of the membrane 220 is formed from a flexible material such as a soft rubber material or a different elastomeric material. An example of the membrane 220 is generally planar and has a shape that generally matches the shape of the applicator 115 (e.g., a circular shape having a similar diameter). As shown in FIG. 2D, an example of the membrane 220 includes a group of dimples 119 or protrusions on the side of the membrane 220 that is opposite the applicator 115. Examples of the dimples 119 are arranged on the membrane 220 so that when assembled, the dimples 119 align with the group of openings of the applicator 115. The shape and size of the dimples can be configured to generally match the shape and size of the openings 117 of the applicator 115. For example, the dimples 119 can have circular shapes and can have diameters of about 0.2 inches. The shapes and arrangements of the dimples 119 can be configured differently to match applicators 115 having different configurations of openings 117.

The rotor 225 is arranged within the head and below the membrane 220. The rotor 225 includes one or more arms 235 that extend in a radial direction (See FIG. 2C) parallel to the membrane 220 and are configured to rotate below the membrane 220. In this regard, an example of the rotor 225 is coupled to the motor 130 via a shaft 230.

During rotation, the arms 235 of the rotor 225 pass over and press against the dimples 119 of different regions of the membrane 220 and move regions of the membrane 220 that are proximate to the dimples 119 (i.e., above the dimples) in and out of the of openings 117 of the applicator 115. This, in turn, creates a pumping action within the openings 117. For example, as shown in FIG. 2A, during a particular moment in the rotation cycle, a left-arm 235a presses against the left-most dimples of the membrane 220 shown in the figure to move corresponding regions on the top of the membrane 220 into the openings 117 of the applicator 115. At the same time, the right arm 235b does not press against the right-most dimples of the membrane 220 shown in the figure. The cyclic movement of these regions of the membrane 220 into the opening 117 of the applicator 115 creates a pumping action that can draw contaminates away from pores 157 of the cleansable surface 152.

In some examples, each arm of the rotor 225 includes a spindle (not shown) and a cylindrically shaped bearing (not shown) arranged on the spindle. During operation, the cylindrically shaped bearing can rotate about a corresponding spindle as the rotor 225 rotates below the membrane 220. This configuration can reduce frictional forces that might otherwise exist between the rotor 225 and the membrane 220.

### III. Third Example Cleansing Device

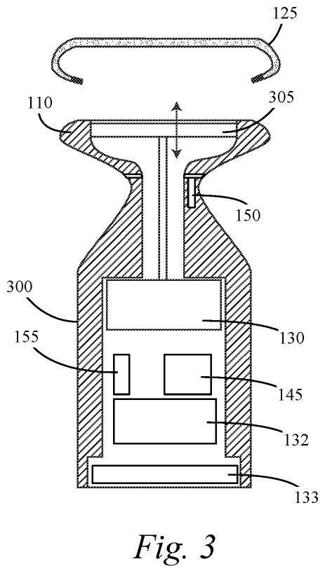

FIG. 3 illustrates a cross-sectional view of a third example of a cleansing device 300 partially disassembled. Referring to the figure, the cleansing device 300 includes a body 105, a head 110, and a piston 305 arranged therein. Additional components that can be arranged in or used with the cleansing device 300 can include a covering 125, a motor 130, a battery 132, charging circuitry 133, a force sensor 150, a haptic device 155, and a controller 145.

The primary difference between the third example cleansing device 100 and the other examples is the use of a piston 305 to pump cleansing agents embedded within the covering 125 into the pores of the cleansable surface 152. In this regard, in an example, the interior surface of the head 110 forms a seal with the perimeter of the piston 305. Pumping action of the piston 305 against the covering causes cleansing agents stored within the covering 125 to move in and out of the pores 157 of the cleansable surface 152.

As noted above, an example of the covering 125 has a hollow cellular structure such as a honeycomb structure, and can have elastomeric properties. The pumping action of the piston 305 causes the cells of the covering 125 to compress and expand against the cleansable surface 152 to thereby move cleansing agents stored in the cells in and out of the pores 157 of the cleansable surface 152.

### IV. Example Cleansing Method

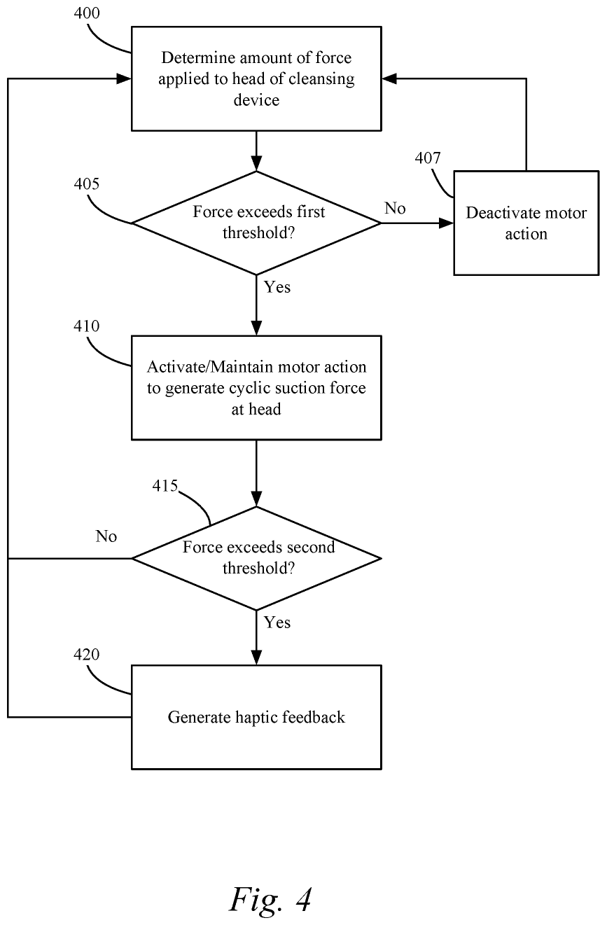

FIG. 4 illustrates examples of operations performed in a method performed by a cleansing device 100. Operation 400 can involve determining an amount of force applied to the head 110 of the cleansing device 100. For example, the head 110 of the cleansing device 100 can be releasably coupled to the body 105. A force sensor 150 can be arranged between the head 110 of the cleansing device 100 and the body 105 of the cleansing device 100. A controller 145 can be arranged within the cleansing device 100 and can be configured to receive information from the force sensor 150 indicative of an amount of force being applied to the head 110.

At operation 405, if the force does not exceed a first threshold, then at operation 407 motor action can be deactivated, and the operations can repeat from operation 400. If the force exceeds the first threshold, then at operation 410, the controller 145 can activate a motor action of the cleansing device 100 to generate a pumping action at the head 110 of the cleansing device 100. For example, in the case of the first example cleansing device 100, the motor action can be to cyclically activate and deactivate the motor 130. This can result in cyclical pumping action by the pump 140, which can cause the diaphragm 120 to move in and out of openings 117 of the applicator 115 to create a pumping action within openings of the applicator 115 arranged in the head 110. In the case of the second example cleansing device 200, the motor action can be to activate the motor 130 to cause the rotor 225 to rotate below the membrane 220 to cause the pumping action at the head 110.

If at operation 415, the force exceeds a second threshold, then at operation 420, the cleansing device 100 can generate haptic feedback to indicate to a user of the cleansing device 100 that an optimal amount of pressure exists between the applicator 115 of the cleansing device 100 and a cleansable surface 152. For example, the controller 145 of the cleansing device 100 can activate a haptic device 155 of the cleansing device 100. In some examples, the controller 145 can generate an audible alert to the user.

### V. Fourth Example Cleansing Device

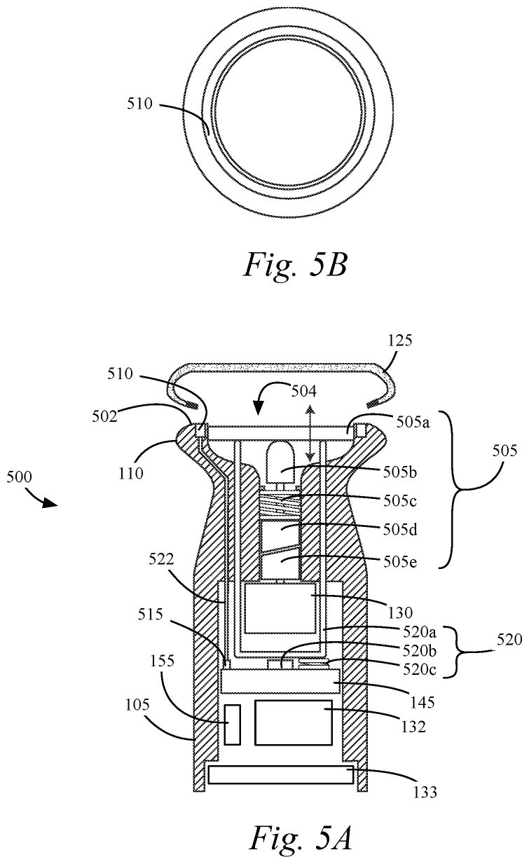

FIG. 5A illustrates a cross-sectional view of an example of a cleansing device 500. FIG. 5B illustrates a top view of the cleansing device 500. The cleansing device 500 comprises a body 105 that defines a handle and a head 110 that is coupled to the body 105. The head 110 comprises a contact surface 502 that further defines an opening 504. The cleansing device 500 further comprises a piston 505a disposed within the opening 504. The piston 505a is configured to move in a reciprocating manner towards and away from the contact surface 502 to create a pumping action, within the opening 504, that is configured to draw contaminates away from pores of a cleansable surface 152 that abuts the contact surface 502 of the head 110. Some examples of the cleansing device 500 further comprise an illumination element 510 and a force sensor assembly 520. Some examples of the cleansing device 500 further comprise a covering 125, a motor 130, a battery 132, charging circuitry 133, a haptic device 155, and a controller 145. Various aspects of these features are described above and not repeated for the sake of brevity.

An example of the piston 505a is part of a piston assembly 505, which further comprises a tip 505b, a resilient member 505c, a cam follower 505d, and a cam 505e. The piston 505a is in mechanical contact with the tip 505b. The tip 505b is coupled (e.g., via a shaft) to the cam follower 505d. An example of the tip 505b is made from an elastomeric material such as a silicone rubber that allows for a degree of mechanical deformation of the tip 505b when the piston head 505a is applying pressure to a cleansable surface 152. That is, when the piston 505a is applying pressure against the cleansable surface 152, the tip 505b can, if necessary, compress to an extent, which facilitates the continued operation of the cam 505e, cam follower 505d, and motor 130 (i.e., preventing these components from jamming). This, in turn, mitigates the chances of any damage occurring to the cam 505e, cam follower 505d, and motor 130 during operation.

An example of the resilient member 505c corresponds to a coil spring. The resilient member is configured to urge the cam follower 505d against the cam 505e. An example of the cam follower 505d is coupled to the tip 505b via a shaft.

An example of the cam 505e is coupled to the motor 130 via a shaft. In operation, rotation of the motor 130 causes a corresponding rotation of the cam 505e. Rotation of the cam 505e causes the cam follower 505d to move in a reciprocating manner (i.e., longitudinally towards and away from the motor 130). The reciprocating movement causes a corresponding reciprocating movement of the tip 505b, which in turn causes a corresponding reciprocating movement or pumping action in the piston 505a. Pumping action of the piston 505a pumps cleansing agents embedded within the covering 125 into the pores of the cleansable surface 152. In this regard, the interior surface of the head 110 can form a seal with the perimeter of the piston head 505. Pumping action of the piston 505a against the covering 125 causes cleansing agents stored within the covering 125 to move in and out of the pores 157 of the cleansable surface 152.

An example of the illumination element 510 is configured to emit light from the head 110. An example of the emitted light facilitates determining a readiness state of the cleansing device 500. For example, white light can be emitted to indicate that the cleansing device 500 is ready for use. Red light can be emitted to indicate a problem of some kind, such as a low charge on the battery, a charging problem, a problem with the motor 130, etc. In some examples, a particular color is emitted to indicate that pressure being applied by the user is too high, which can, in some cases, prevent reciprocation of the piston 505a. In some examples, a pattern of light (e.g., flashing at a particular rate) can be used to convey the status of the cleansing device 500.

An example of the illumination element 510 corresponds to a clear or translucent material that is circumferentially arranged around the opening 504 in the head 110. In an example, a light source 515, such as a light-emitting diode (LED) or the like, is in optical communication with the illumination element 510. For instance, an example of the light source 515 is positioned on the controller 145, and a light pipe 522 is optically coupled to the light source 515 and the illumination element 510. The light pipe 522 communicates light emitted by the light source 515 to the illumination element 510. In other examples, the light source 515 is embedded within or in proximity to the illumination element 510 (e.g., within the head 110). In an example of this configuration, electrical conductors electrically couple the light source 515 to the controller 145.

An example of the force sensor assembly 520 comprises a contact member 520a, a resilient member 520b, and a contact sensor 520c. An example of the contact member 520a is formed from a rigid material and has a U-shaped configuration, as illustrated. A first end of the contact member 520a is in contact with the bottom of the piston 505a or is positioned a margin below the piston 505a. The opposite/second end of the contact member 520a is positioned on a contact sensor 520c. The resilient member 520b urges the contact member 520a towards the piston 505a and away from the contact sensor 520c.

An example of the contact sensor 520c is a switch that provides a binary state (i.e., on or off). Another example of the contact sensor 520c provides an output value proportional to the amount of pressure placed on the contact sensor 520c, which is related to the amount of pressure placed against the piston 505a. This configuration facilitates performing different actions depending on the amount of pressure. For instance, a first amount of pressure can indicate that a correct amount of pressure is being applied to the piston 505a and can be used to activate the reciprocating movement of the piston 505a. A second, higher amount of pressure can trigger a warning to the user (e.g., via haptic feedback) that pressure applied to the piston 505a should be reduced. A third even higher amount of pressure can trigger the reciprocating movement of the piston 505a to cease.

In an example operation, the piston 505a moves in a reciprocating manner as described above. When a nominal pressure is applied to the piston 505a of the cleansing device, the contact member 520a either remains stationary or moves to an extent with the piston 505a. In this mode, the extent by which the second end of the contact member 520a moves is less than the extent required for the second end of the contact member 520a to press the contact sensor 520c. When excessive pressure is applied to the piston 505a of the cleansing device 500 (e.g., by the user applying too much pressure against the cleansable surface 152), the piston 505a moves inward (i.e., towards the motor 130), pushing on the first end of the contact member 520a. This movement, in turn, causes the second of the contact member 520a to press against and actuate the contact sensor 502c. In an example, the actuation of the contact sensor 502c causes an indication to be generated to alert the user of the excessive pressure. For instance, in an example, the illumination element emits/flashes light of a particular color when the contact sensor 502c is actuated. In another example, haptic feedback is generated when the contact sensor 502c is actuated.

### VI. Fifth Example Cleansing Device

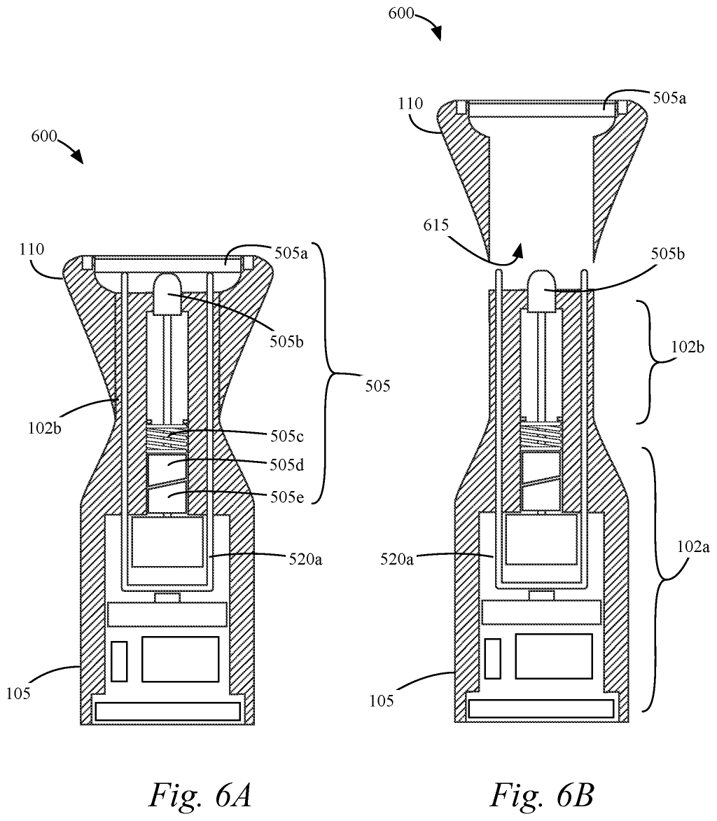

FIGS. 6A and 6B illustrate cross-sectional views of an example of a cleansing device 600 that has a detachable head 110. The cleansing device 600 shares various elements with the cleansing device 500 described above and shown in FIG. 5A. A description of these elements is not repeated for the sake of brevity.

An example of the body 105 of the cleansing device 600 comprises a handle region 102a an elongated neck region 102b that extends from the handle region 102a. The neck region 102b is configured to slide within a complementary channel 615 defined in the head 110. In an example, when the head 110 is removed, the tip 505b of the piston assembly 505 and the first end of the contact member 520a are exposed, as shown in FIG. 6B. When the head 110 is slid over the neck region 102b, the tip 505b of the piston assembly 505 and the first end of the contact member 520a come into contact with or within a margin of the piston 505a. In some examples, the neck region 102b and the head 110 define complementary features that facilitate releasably locking the head 110 to the body (e.g., complementary threads, one or more release buttons, etc.).

An example of the cleansing device 600 can comprise the illumination element 510 described above in FIG. 5. This example includes a light source 515 that is in optical communication with the illumination element 510 via, for example, a light pipe 522. In this example, a first section of the light pipe 522 is positioned in the body 105, and a second section of the light pipe 522 is positioned in the head 110. When the head 110 is attached to the body 105, respective ends of the first and second sections of the light pipe 522 align with one another to facilitate communicating light from a light source 515 in the body 105 to the illumination element 510.

In another example, the illumination element 510 can comprise the light source. In this example, an LED or the like is positioned within the head 110 and in proximity to or embedded within the illumination element 510. In this example, a pair of electrical contacts is arranged on the neck region 102b of the body 105 (e.g., on the outside surface of the neck region 102b), and a corresponding pair of electrical contacts is arranged within the channel 615 of the head 110. When the head 110 is attached to the body 105, the electrical contacts on the neck region 102b make contact with the electrical contacts within the head 110 to facilitate powering the light source in the head 110.

### VII. Example Charging Stand

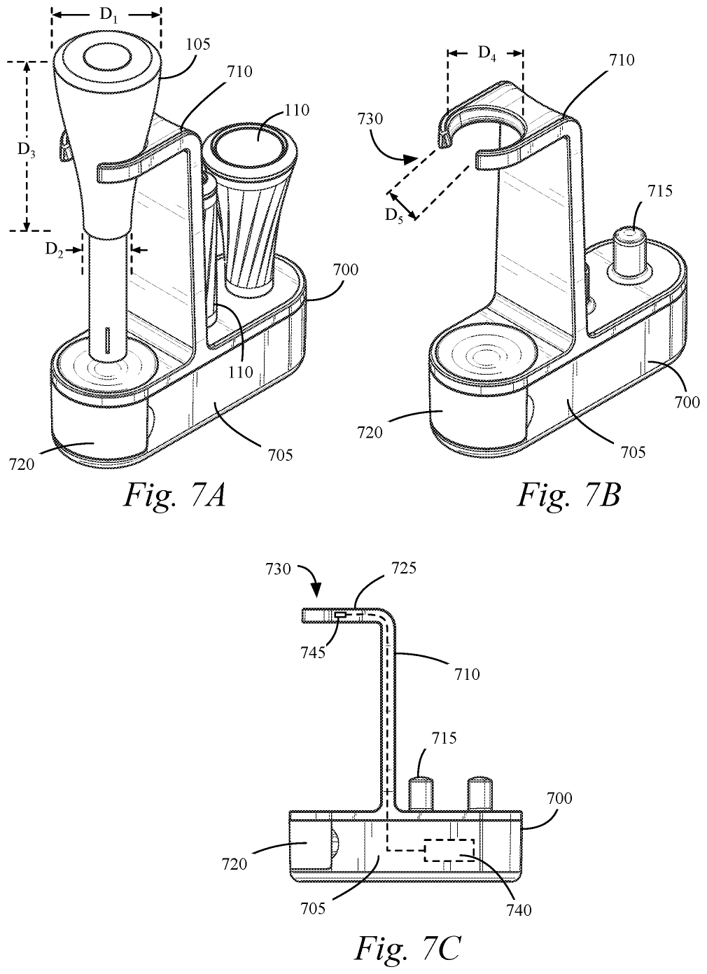

FIGS. 7A-7C illustrate various views of an example of charging stand 700 for any of the cleansing devices described above. The charging stand 700 includes a base 705 and arm 710 that extends from the base 705.

An example of the base 705 includes features that facilitate securing one or more heads 110 of the cleansing device to the base 705. For instance, an example of the base 705 comprises a pair of protrusions 715 on the top surface configured to fit within the channels 615 of the heads 110. Other examples can define a pair of recesses into which the heads 110 can partially extend.

An example of the base 705 includes a storage tray 720 configured to hold items that can be used in connection with the cleansing device 600. For example, replacement cleansing pads and/or cleansing fluids can be stored in the storage tray 720.

An example of the arm 710 includes an upper section 725 that defines an opening 730 for receiving the body 105 of the cleansing device 600. An example of the opening 730 is sized to allow the body 105 to slide into the opening 730 in a longitudinal direction towards the base 705 to an extent. In this regard, in an example cleansing device, the body tapers from a first diameter, D₁ (e.g., 43 mm), at a region opposite the head to a second diameter, D₂ (e.g., 20 mm) that is smaller than the first diameter at a region towards the head. An example of the length of the body over which the body tapers, D₃, is about 83 mm. In this case, an example of the opening has a diameter, D₄, that is between the first diameter and the second diameter (e.g., about 35 mm. In this example, the head 110 can be removed to facilitate securing the body 105 to the base 705.

As more clearly illustrated in FIG. 7B, in another example, the upper section 725 is open on one side (e.g., defines a C-like shape) that facilitates laterally inserting the body 105 into the opening 730. This configuration facilitates securing the body 105 to the base 705 without requiring the removal of the head 110. An example of the side opening has a width, D₅, that is between the first diameter and the second diameter of the body of the cleansing device (e.g., 25 mm).

An example of the base 705 includes charging circuitry 740 that facilitates charging a battery 132 of the cleansing device. An example of the charging circuitry 740 includes an AC-DC or DC-DC converter that converts a line voltage (e.g., 120 VAC) to a nominal DC voltage suitable for charging the battery 132. Another example of the charging circuitry 740 includes a battery that can be charged to facilitate extended use of the cleansing device (e.g., a battery having a 10× capacity compared to the battery 132 within the cleaning device). An example of the charging circuitry 740 includes wireless charging capabilities that facilitate wirelessly charging the battery 132 of the cleansing device. Following this example, an example of the arm 710 includes energy transmitting coils 745 configured to wirelessly transmit energy to the body 105 of the cleansing device. In another example, a pair of electrical contacts are provided on an inside surface of the opening 730 and are configured to make electrical contact with a corresponding pair of electrical contacts provided on the outside surface of the body 105 of the cleansing device.

### VIII. Other Examples

Other steaming device implementations are elucidated by the examples set forth below. For instance, an example of a first cleansing device comprises a body that defines a handle; a head mechanically coupled to the body; an applicator arranged on a top of the head. The applicator includes an application surface and a back surface, and defines a plurality of openings. The cleansing device further comprises a diaphragm disposed within the head and against the back surface of the applicator. The diaphragm is configured to move in a reciprocating manner towards and away from the back surface of the applicator to create a pumping action within the plurality of openings that is configured to draw contaminates away from pores of a cleansable surface that abuts the application surface of the applicator.

In an example of the first cleansing device, the diaphragm defines a plurality of dimples configured to align with the plurality of openings of the applicator.

An example of the first cleansing device further comprises a covering configured to cover the applicator. The covering includes a cleansing agent. The pumping action forces the cleansing agent into and out of the pores of the cleansable surface. In an example of this cleansing device, the covering includes hollow cellular structures to retain cleansing fluids or cleansing compounds. The hollow cellular structures align with a direction of movement of the diaphragm.

In an example of the first cleansing device, the head is removably coupled to the body.

In an example of the first cleansing device, the body tapers from a first diameter at a region opposite the head to a second diameter that is smaller than the first diameter at a region towards the head. An example of the first diameter is about 43 mm, and an example of the second diameter is about 20 mm. An example of the length of the body over which the body tapers is about 83 mm.

In an example of the first cleansing device, the applicator is formed from a flexible material and is configured to conform to a shape of the cleansable surface.

An example of the first cleansing device further comprises a motor disposed within the body configured to move the diaphragm in the reciprocating manner. In an example of this cleansing device, the body defines a neck that is configured to couple the head to the body, and the neck defines a channel. This cleansing device further comprises a pump disposed within the channel and mechanically coupled to the motor. The pump is configured to generate a cyclical change in pressure behind the diaphragm that causes the diaphragm to move in the reciprocating manner.

An example of the first cleansing device further comprises a controller arranged within the body and a force sensor arranged within the head. The force sensor is configured to provide information to the controller that facilitates determining, by the controller, an amount of force applied to the head when the cleansing device is in use. An example of this cleansing device further comprises a haptic device arranged within the body. When the amount of force exceeds a first threshold, the controller controls the haptic device to generate first haptic feedback.

An example of a first charging stand for any of the cleansing devices disclosed herein comprises a base, and an arm that extends from the base. The arm comprises an upper section that defines an opening for receiving the body of the cleansing device. The opening is sized to allow the body to slide into the opening in a longitudinal direction towards the base to an extent.

In an example where the body of the cleansing device tapers from a first diameter at a region opposite the head to a second diameter that is smaller than the first diameter at a region towards the head, a diameter of the opening is between the first diameter and the second diameter. In an example, the diameter of the opening is about 35 mm.

In an example of the first charging stand, the upper section defines a C-like shape with an opening on one side that is configured to facilitate lateral insertion of the body into the opening. In an example where the body of the cleansing device tapers from a first diameter at a region opposite the head to a second diameter that is smaller than the first diameter at a region towards the head, a width of the opening on the one side is between the first diameter and the second diameter of the body of the cleansing device. In an example, the diameter of the opening on the one side is about 35 mm.

An example of the first charging stand comprises charging circuitry that facilitates charging a battery of the cleansing device. An example of the charging circuitry comprises wireless charging circuitry that facilitates wireless charging of the battery of the cleansing device.

An example of the first charging stand comprises a storage tray configured to hold items that can be used in connection with the cleansing device.

An example of a cleansing kit comprises any one of the examples of cleansing devices and any one of the examples of charging stands described above.

Other variations of the examples described above are contemplated. For example, a covering 125 for a cleansing device 100 can be provided. The cleansing device 100 can include a head 110 that includes an applicator 115. The covering 125 can include an elastic band 118 arranged around the perimeter of the covering 125. The elastic band 118 can facilitate stretching the covering 125, which can further facilitate sliding the covering 125 over the head 110 of the cleansing device 100. The covering 125 can include a hollow cellular structure configured to retain fluid or cleansing compound(s).

The applicator 115 can include an application surface and a back surface and can define a plurality of openings 117. A diaphragm 120 can be disposed against the back surface of the applicator 115. The diaphragm 120 can be configured to move in a reciprocating manner towards and away from the back surface of the applicator 115 to create a pumping action within the openings 117.

The hollow cellular structures of the covering 125 can align with the direction of the movement of the diaphragm 120. The pumping action forces the cleansing agent in the hollow cellular structures in and out of pores 157 of a cleansable surface 152.

### CONCLUSION

While the systems and methods of operation have been described with reference to certain examples, it will be understood by those skilled in the art that various changes can be made and equivalents can be substituted without departing from the scope of the claims. Therefore, it is intended that the present methods and systems not be limited to the particular examples disclosed, but that the disclosed methods and systems include all embodiments falling within the scope of the appended claims.

1. A cleansing device comprising:
a body that defines a handle;
a head coupled to the body, wherein the head comprises a contact surface that further defines an opening; and
a piston disposed within the opening, wherein the piston is configured to move in a reciprocating manner towards and away from the contact surface to create a pumping action within the opening that is configured to draw contaminates away from pores of a cleansable surface that abuts the contact surface of the head.

2. The cleansing device according to claim 1, further comprising a motor disposed within the body configured to move the piston in the reciprocating manner.

3. The cleansing device according to claim 2, further comprising a cam coupled to the motor and a cam follower coupled to the piston, where rotation of the cam causes the cam follower and the piston to move in the reciprocating manner.

4. The cleansing device according to claim 1, further comprising a covering configured to cover the contact surface, wherein the covering includes a cleansing agent, wherein the pumping action forces the cleansing agent into and out of the pores of the cleansable surface.

5. The cleansing device according to claim 4, wherein the covering includes hollow cellular structures to retain cleansing fluids or cleansing compounds, wherein the hollow cellular structures align with a direction of movement of the piston.

6. The cleansing device according to claim 1, wherein the head is removably coupled to the body.

7. The cleansing device according to claim 1, wherein the contact surface comprises a flexible material, and the contact surface is configured to conform to a shape of the cleansable surface.

8. The cleansing device according to claim 1, wherein the head further comprises an illumination element configured to emit light.

9. The cleansing device according to claim 1, further comprising:
a controller arranged within the body; and
a force sensor assembly configured to indicate to the controller an amount of force applied to the contact surface.

10. The cleansing device according to claim 9, wherein when the amount of force exceeds a predetermined threshold, the controller causes the piston to cease movement.

11. A cleansing device comprising:
a body that defines a handle;
a head mechanically coupled to the body;
an applicator arranged on a top of the head, wherein the applicator includes an application surface and a back surface, and defines a plurality of openings;
a membrane disposed within the head and against the back surface of the applicator, wherein the membrane includes a top side configured to abut a backside of the applicator and a bottom side that defines a plurality of dimples, wherein the plurality of dimples are configured to align with the plurality of openings of the applicator; and
a rotor arranged within the head and below the membrane, wherein the rotor includes one or more arms that extend in a radial direction parallel to the membrane, and the one or more arms are configured to rotate below the membrane and press against the dimples during rotation to cyclically move regions of the membrane proximate the dimples in and out of the plurality of openings to create a pumping action within the plurality of openings to draw contaminates away from pores of a cleansable surface that abuts the application surface of the applicator.

12. The cleansing device according to claim 11, further comprising a covering configured to cover the applicator, wherein the covering includes a cleansing agent, wherein the pumping action the cleansing agent into and out of the pores of the cleansable surface.

13. The cleansing device according to claim 12, wherein the covering includes hollow cellular structures to retain cleansing fluids or cleansing compounds, wherein the hollow cellular structures align with a direction of movement of the membrane.

14. The cleansing device according to claim 11, wherein the head is removably coupled to the body.

15. The cleansing device according to claim 11, wherein the applicator is formed from a flexible material and is configured to conform to a shape of the cleansable surface.

16. The cleansing device according to claim 11, further comprising a motor disposed within the body configured to rotate the one or more arms.

17. The cleansing device according to claim 11, further comprising:
a controller arranged within the body; and
a force sensor arranged the head, wherein the force sensor is configured to provide information to the controller that facilitates determining, by the controller, an amount of force applied to the head when the cleansing device is in use.

18. The cleansing device according to claim 17, further comprising:
a haptic device arranged within the body, wherein when the amount of force exceeds a first threshold, the controller controls the haptic device to generate first haptic feedback.

19. A covering for a cleansing device comprising:
an elastic band arranged around a perimeter of the covering that facilitates securing the covering to a head of a cleansing device; and
a cleansing agent impregnated within the covering, wherein the head of the cleansing device includes an applicator that includes:
an application surface and a back surface, and defines a plurality of openings; and
a diaphragm disposed against the back surface of the applicator, wherein the diaphragm is configured to move in a reciprocating manner towards and away from the back surface of the applicator to create a pumping action within the plurality of openings, wherein the pumping action forces the cleansing agent in and out of pores of a cleansable surface.

20. The cleansing device according to claim 19, wherein the covering includes hollow cellular structures to retain cleansing fluids or cleansing compounds, wherein the hollow cellular structures align with a direction of movement of the diaphragm.
